(19) United States
(12) Patent Application Publication
(10) Pub. No.: US 2026/0202669 A1
(43) Pub. Date: Jul. 16, 2026

(54) Head-up Display in Which a Concave Mirror Is Optimized and/or Lowered into the Park Position by Way of an Eccentric Bearing With a Separate Drive

(71) Applicant: Bayerische Motoren Werke Aktiengesellschaft, Muenchen (DE)

(72) Inventor: Holger RUHMKE, Ingolstadt (DE)

(21) Appl. No.: 19/133,528

(22) PCT Filed: Feb. 21, 2024
(86) PCT No.: PCT/DE2024/100140

§ 371 Date: May 28, 2025

(30) Foreign Application Priority Data
Mar. 2, 2023 (DE) 10 2023 105 203.9

(51) Int. Cl. G02B 27/01; B60K 35/231; B60K 35/235; G02B 1/11; G02B 27/00

(52) U.S. Cl. CPC G02B 27/0149; B60K 35/231; B60K 35/235; G02B 1/11; G02B 27/0093; G02B 27/0101; G02B 2027/013; G02B 2027/015; G02B 2027/0154

(57) ABSTRACT

A projection unit includes an imaging unit for creating a light beam, and a concave mirror arranged in the beam path such that the light beam leaves the projection unit with a predetermined shape and direction to be reflected to the eye box of a user by a partly transparent reflection pane, and to display the display content in the form of a virtual image behind the reflection pane. The concave mirror is rotatable about a mirror shaft that is rotatably mounted in a primary bearing, and the primary bearing is mounted off-center in a secondary bearing at an end of the mirror shaft, the secondary bearing being drivable to a rotation about its eccentric axis fixed in relation to the projection unit by an independently controllable eccentric drive, to bring about a translational movement of the mirror shaft and hence of the concave mirror in a direction transverse thereto.

### CROSS REFERENCE TO RELATED APPLICATION

This application contains subject matter related to U.S. application Ser. No. ______, entitled “Head-up Display in Which a Concave Mirror Is Optimized and/or Lowered into the Park Position by Way of an Eccentric Bearing,” filed on even date herewith (Attorney Docket No. 080437.PI778US).

### BACKGROUND AND SUMMARY

The invention relates to a projector unit for a see-through or transparent display, also known as a head-up display (HUD), in particular for a motor vehicle or some other land, air, or water vehicle. Transparent displays of this type are designed to generate a virtual image projected into a user's field of vision reflected on the windscreen, or a combiner panel in the user's field of vision. The invention also relates to such a transparent display and a vehicle equipped therewith.

Head-up displays are used in particular in motor vehicles to display information regarding speed limits, as well as other navigational or vehicle information in the form of a virtual image superimposed over what the driver sees in front of the vehicle, such that there is no need to look away from the street to see this information. The HUD has a reflective panel in the driver's field of vision, which is substantially transparent to ambient light striking it from the back, and either forms part of the windshield, or is a combiner panel inside the vehicle in front of the windshield. A conventional HUD has a projector unit in the dashboard beneath the windshield. This normally contains a display that generates light beams containing the desired content, and imaging and projection optics that focus the light beams onto the reflective panel such that they are reflected into the driver's eyes, resulting in a virtual image that is seen in the appropriate size and at the appropriate distance behind the reflective panel. Conventional HUD projection optics contain a concave mirror that corresponds to, and therefore limits, the size of the virtual display.

Implementation of these head-up displays in a vehicle is extremely complex, due in part to the limited installation space. An important component of the projector unit is a transparent cover lens on the housing for the projector unit where light is emitted. The cover lens is designed to prevent reflections, in particular from outside, interfering with the HUD beam path, and thus obscuring the driver's vision. For this reason, the cover lens has a specific curvature that deflects disruptive reflections, also referred to as geometric anti-reflection coating, which occupies a significant vertical portion of the cover lens. This requires that the design of the cover lens take into account the available installation space. The design of the cover lens is primarily dictated by the concave mirror, because the cover lens must be at a certain minimum vertical distance to the concave mirror.

When the HUD is not in use, the concave mirror is normally in its “parked” position, where the vertical distance between the cover lens and the mirror is usually the least. The parked position is normally reached by rotating the mirror such that it is no longer in the beam path of the HUD in order to prevent undesired focusing of the light entering the projector unit from the outside onto the HUD optics and electronic components, which are both light-and heat-sensitive.

The size of the concave mirror is dictated by optical/mechanical restrictions. Different drivers will view the display from different positions, due to their heights. To ensure that each driver has an optimal HUD display and eyebox position, adjustments can be made by rotating the mirror. The portion of the mirror that can be used effectively for this usually varies for different drivers due to the different beam paths for individual eyebox positions. To be able to accommodate all sizes, the mirror is normally larger than it would need to be if it were not adjustable. The optical performance is optimized taking the different adjustment possibilities for the mirror into account. This normally requires compromises, because the limited rotational range restricts the extent to which the position can be optimized.

The object of the present invention is to create a better projector unit with regard to the installation space, the optical performance, and/or other aspects, for a transparent display, and an improved operation thereof, which can be used in particular in a vehicle.

This is achieved with a projector unit and a transparent display containing such, an associated operating method, a control unit for such, and a vehicle equipped therewith, all according to the claimed invention. All features and effects specified in the claims and following description of the projector unit also apply to the transparent display, the operating method, the control unit, and the vehicle, and vice versa.

According to a first aspect, the projector unit is intended for a transparent display that can be used in particular in a vehicle. The transparent display can be a head-up display (HUD). The vehicle can be a motor vehicle, or any land, air, or water vehicle.

The projector unit contains an imaging unit that generates an image of the desired content, which can fundamentally make use of any imaging technology that is suitable for use in a vehicle. This can be a display in particular, e.g. a flat screen or waveguide display, but it can also comprise a projector system, e.g. a DLP projector, or a diffusor, etc.

The projector unit contains (in addition to other optical elements for focusing and deflecting light beams) a concave mirror placed in the beam path emitted from the imaging unit, that reflects the light beams from the projector unit in a predefined shape and direction, which are then reflected by an at least partially transparent reflective panel in the user's field of vision, into the user's eyebox, thus presenting the user with the display content in the form of a virtual image behind the reflective panel. The reflective panel can be part of the windshield, or it can be a separate combiner panel. It is therefore part of the transparent display described below, but is not necessarily part of the projector unit, which could also be produced and distributed separately if the windshield is used. If a combiner is used, it can also be (moveably) integrated in the projector unit in the conventional manner. The eyebox for the transparent display is understood to be a two or three dimensional space in which the virtual image can be clearly seen by the user.

The concave mirror can be rotated by a drive unit about a rotational shaft, which forms a permanent component of the mirror, or is otherwise permanently connected thereto, to adjust the eyebox to users of different sizes and postures. The drive unit can be an electric motor or some other type of actuator, which is connected directly, or through a gear system, to the mirror shaft, in order to apply a torque thereto. The mirror shaft can be rotatably supported at each end in a primary bearing. If one end of the mirror shaft is supported in a primary bearing that remains stationary in relation to the projector unit, it can be connected to the drive unit. Otherwise, the drive can be integrated in a moving primary bearing.

The primary bearing on at least one end of the mirror shaft is supported at a point offset from the center of an independent secondary bearing. In other words, this secondary bearing (also referred to as an eccentric bearing) can be rotated by an eccentric drive about an eccentric axis that remains stationary in relation to the projector unit, which can be operated independently of the drive unit for the mirror shaft. The eccentric drive can contain a tappet that applies a torque to the secondary bearing, which is rotated about the eccentric axis by a motor not connected to the mirror shaft, and engages in a form-fitting manner in the secondary bearing. The amount and/or direction of the torques applied by the separate drive units to the mirror shaft and the eccentric may vary over time.

When the secondary bearing is rotated about its eccentric axis, the primary bearing also rotates about the eccentric axis. This results in a nearly translatory movement of the mirror shaft, thus moving the mirror transversally in relation to its mirror shaft. The resulting freedom of movement for adjusting the position of the mirror can be used to optimize various aspects of its optical performance, size, and/or placement in the available installation space. Some examples of this shall be explained below. In particular, this can also solve problems specified in the introduction.

The transversal movement of the mirror shaft, and therefore the mirror itself, obtained with the eccentric drive can be used to lower the mirror along the vertical axis defined by the vehicle. Consequently, the mirror can be lowered to its parked position to a greater extent than with conventional stationary bearings for the mirror shaft, thus overcoming the problems regarding installation space with respect to the cover lens for the projector unit specified above. This translatory movement of the mirror shaft can also be used to optimize the optical performance and/or size of the mirror when the projector unit is in use, in particular with regard to adjusting the eyebox.

A concrete relationship between the rotation of the secondary bearing and the translatory movement of the mirror transverse to its rotational axis can be affected by various structural details, e.g. the radial spacing and angular position of the primary bearing in the secondary bearing.

The primary bearings on one or both ends of the mirror shaft can form spherical heads that allow for maximum freedom of movement for the mirror shaft. The primary bearing in the secondary bearing can be stationary, in particular at a fixed point in relation to the secondary bearing, at a predetermined radial distance to the eccentric axis. To enable maximum movement of the mirror shaft, the primary bearing can be supported in the secondary bearing with sliding or rolling bearings.

One of the ideas for the above projector unit is therefore to support the mirror shaft off-center in a rotating secondary bearing, which has a different rotational axis, that can be rotated independently by a separate eccentric drive, in order to adjust the position of the concave mirror. This can be designed to move the mirror to its parked position, and/or to adjust the position thereof, or the eyebox, to a specific user when using the transparent display, e.g. when driving the vehicle. This can optimize the optical performance of the overall system, and/or the necessary installation space for the transparent display by minimizing the size of the mirror and/or further lowering or raising, or otherwise moving the rotating mirror transversally.

As a result of using two independent drives, the rotation of the mirror about its mirror shaft and about the stationary eccentric axis can be carried out simultaneously or successively. This allows the distance between the mirror and the cover lens to be kept to a maximum while it is being lowered to its parked position. Furthermore, the mirror can be lowered to its parked position from any operating position arising when the projector unit is in use. This also maximizes the range and precision of adjustment when positioning and orienting the concave mirror to a specific eyebox, or to the movement of the user. This eyebox adjustment can be based on eye-tracking, and thus be fully automated.

Although embodiments of the invention are mostly described with an eccentric bearing on just one end of the mirror shaft, therefore raising and lowering the mirror at just one end, it is also possible to have eccentric adjustments at both ends of the mirror shaft, with the same fundamental structure and functioning. This allows for an even greater reduction in the size of the mirror, and/or enables greater optimization of the eyebox adjustment, and/or results in a greater distance between the mirror and the cover lens in the parked position.

The drive unit for the mirror shaft and the drive unit for the eccentric bearing can each have a separate motor, with which they can be controlled independently. They could also share a motor through a coupling, with which they can then be controlled separately.

In one embodiment, the projector unit also has a protective housing that protects the components of the projector unit, which has a transparent cover lens through which light beams exiting the projector unit are transmitted. The parked position can be obtained by angling the mirror shaft, such that the focal point, or an optical axis of the concave mirror, lies outside the beam path intended for the operation of the projector unit. In this embodiment, the mirror shaft is supported in the secondary bearing such that when the mirror is moved from its operating position to the parked position, rotation of the secondary bearing by the eccentric drive results in a translatory movement of the mirror shaft, thus moving the mirror away from the cover lens. If the projector unit is installed in a vehicle's dashboard, the mirror shaft is lowered vertically in relation to the vehicle (at least at one end). Purely by way of example, the appropriate positions of the primary bearing and a tappet for the eccentric drive in the secondary bearing are shown in FIG. 2.

The mirror shaft and the eccentric axis can be basically parallel and at a predefined distance to one another. Alternatively, they can also be angled in relation one another, in particular at a predefined minimal distance to one another, such that the axes do not cross. In particular, the eccentric axis and an orthogonal projection of the mirror shaft can form an acute angle of substantially less than 90°, e.g. less than 80°, 70°, 60°, 50°, 40°, 30°, or 20°.

In a specific embodiment, the mirror shaft and/or its primary bearing and/or the secondary bearing have an automatic shaft length adjustor, such that the length of the shaft when the secondary bearing is rotated is automatically adjusted to the potentially varying distance between the primary bearings at its ends. By way of example, a spring that compensates for different distances can be placed on one or both of its ends, or the mirror shaft can be telescoping, formed by two coaxial rods that fit together, which are then adjusted to different lengths by a spring pushing them apart to fit the available space between the bearings.

Another aspect of the invention relates to a method for operating the projector unit described herein. As stated above, this method allows for the mirror shaft to be operated by the mirror shaft drive and the secondary bearing to be operated by the eccentric drive, successively or simultaneously, in order to adjust the mirror when the projector unit is in use, in particular to adjust the eyebox position. They can also be operated successively or simultaneously to move the mirror to its parked position.

Another aspect of the invention relates to a control unit with which the method can be executed automatically.

Another aspect of the invention relates to a transparent display, in particular for use in a vehicle. The transparent display contains not only the projector unit disclosed herein, but also an at least partially transparent reflective panel placed in the beam path for the light emitted from the projector unit, which either forms part of the windshield, or some other window in the vehicle, or is a combiner panel. This reflective panel is placed in the user's field of vision, e.g. the driver or another vehicle occupant, such that the light from the projector is reflected into an eyebox for the user, thus presenting the display content in the form of a virtual image behind the reflective panel when the transparent display is in use. In particular, the transparent display can also contain the control unit described above.

Another aspect of the invention relates to a vehicle, in particular a motor vehicle, or some other land, air, or water vehicle. The spatial orientation terms used herein such as “above,” “below,” “in front of,” “lateral,” “horizontal,” “vertical,” etc. relate to the normal cartesian coordinate system for the vehicle, extending along the longitudinal, lateral, and vertical axes thereof.

The vehicle has a windshield that at least partially delimits the interior of the vehicle, in particular at the front, and is equipped with the above transparent display, the projector unit for which is located in the passenger compartment, while the reflective panel is part of the windshield or a combiner panel. By way of example, The projector unit can be directly beneath the upper surface of the vehicle's dashboard, such that the light emitted from the projector unit strikes the windshield above the dashboard, or a combiner in the driver's field of vision, or that of another passenger.

The translatory movement of the mirror shaft resulting from a rotation of the secondary bearing results in a lowering or raising thereof at one or both ends along the vertical axis of the cartesian coordinate system for the vehicle.

In one embodiment, the mirror can be moved to the parked position in the projector unit by angling the mirror shaft to a specific degree. The position of the mirror shaft in the primary bearing is set electromechanically or mechanically for a predetermined operating angular range for adjusting the eyebox when the projector unit is in use, which suppresses oscillations of the mirror caused by the motion of the vehicle. The projector unit is designed to automatically override this setting when moving the mirror into the parked position.

The above aspects of the invention, and their embodiments and specific designs shall be explained in greater detail below in reference to the examples illustrated in the drawings. The drawings are schematic illustrations, and therefore not to be regarded as true to scale.

### BRIEF DESCRIPTION OF THE DRAWINGS

FIG. 1 shows a vertical longitudinal cut through a section of a motor vehicle with a transparent display according to an exemplary embodiment of the invention.

FIG. 2 shows a cross sectional view of an example of an eccentric bearing for the mirror shaft of the mirror in the transparent display shown in FIG. 1 in a secondary bearing that can rotate independently of the mirror shaft, looking along the length of the mirror shaft.

FIG. 3a shows a longitudinal section of the concave mirror from FIG. 2, and its eccentric bearing in the rotational secondary bearing, looking toward the mirror shaft, when the mirror is in use.

FIG. 3b shows the same longitudinal section shown in FIG. 3a, when the mirror is in the parked position, in which it has been lowered vertically from the operating position shown in FIG. 3a, not only by rotating it about its mirror shaft, but also lowering it vertically through an independent rotation of the secondary bearing.

### DETAILED DESCRIPTION OF THE DRAWINGS

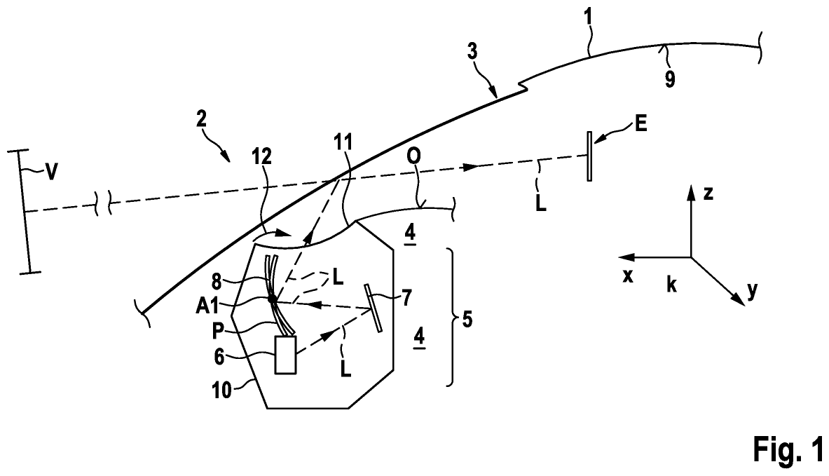

All of the various embodiments, variations and specific design features of the projector unit, the associated operating method, and the control unit, as well as the transparent display and the vehicle according to the above aspects of the invention, can be implemented in the examples shown in FIGS. 1 to 3b, in particular as alternatives or in addition to the features shown therein. For this reason, they will not all be repeated below. The same applies accordingly to the definitions of terms given above, and effects in relation to individual features shown in FIGS. 1-3b.

FIG. 1 shows a vertical longitudinal cut through a section of a vehicle 1 that has a transparent display 2 according to one exemplary embodiment of the invention. The transparent display 2 is a head-up display (HUD) in this case, purely by way of example. Spatial orientation terms used in the description of this and the other examples, e.g. “horizontal,” “vertical,” “above,” “below,” “front,” “back,” etc. relate to the normal cartesian coordinate system K for the vehicle 1, with longitudinal, lateral, and vertical axes X, Y and Z.

The transparent display 2 is designed to generate a virtual image V in a user's field of vision, e.g. that of a driver of the vehicle 1, indicated in FIG. 1 merely by an eyebox E in the passenger compartment of the vehicle 1. In this example, the eyebox E is defined as a two dimensional space, perpendicular to the central beam in the transparent display 2, from which space the virtual image V can be seen with the intended quality. The vehicle 1 is a motor vehicle in this case. It is indicated in FIG. 1 solely by its windshield 3, a dashboard 4 below it, and a roof 9 above it.

The transparent display 2 contains a projector unit 5, which is below the windshield 3, inside the dashboard 4 in this example, and protected by a housing 10 against any contaminants such as dust or moisture. The projector unit 5 contains an imaging unit 6 for generating light beams L containing the desired display content. The light beams L emitted by the imaging unit 6 are indicated by the central beam in the transparent display 2, which exits the middle of the imaging unit 6 in the middle of the eyebox E.

In this example, there is an optional flat mirror 7 (that can be omitted in embodiments of the present invention), which reflects the beam toward a concave mirror 8. The curved surface of the concave mirror 8 that faces the flat mirror 7 (or the imaging unit 6, if this is omitted), forms a surface that the light beams L are reflected on after exiting the projector unit 5 in a specific shape and direction, to subsequently be reflected by the windshield 3 into the eyebox E. The windshield 3 therefore acts as the reflection panel for the transparent display 2.

The housing 10 for the projector unit 5 has a transparent cover lens 11 facing the windshield 3, through which the light beams L pass, which protects the projector unit 5 against mechanical disruptions, as well as against disruptive reflections of the sun and ambient light. This cover lens 11 is somewhat deeper than the adjacent surface O of the dashboard 4, and has a concave outer antireflection surface. This requires a long cover lens 11 along the vertical axis Z, as can be seen in FIG. 1.

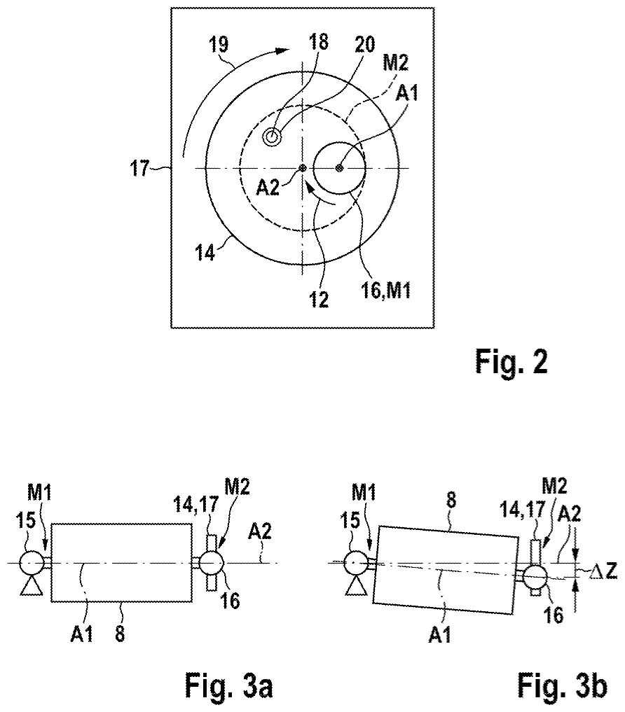

The concave mirror 8 can be rotated about a mirror shaft A1 by a first electrical drive M1 (see FIGS. 2-3b), in order to adjust the position of the eyebox E to different sized users and their postures. The concave mirror 8 can also be moved to a parked position P by angling the mirror shaft A1 about which the mirror rotates to a specific position, in which the focus, or optical axis of the concave mirror 8 lies outside the beam path of the projector unit 5. Rotation 12 of the mirror shaft A1 to move the mirror 8 from the operating position shown in FIGS. 1 and 3a, into the parked position P indicated schematically in FIGS. 1 and 3b, is indicated in FIG. 1 by a curved arrow.

As FIG. 1 shows, the concave mirror 8 extends vertically Z to the greatest extent in its parked position P, for which reason the cover lens 11 above it must be large enough to accommodate it. This restricts the design of the dashboard 4 and other components of the vehicle 1 near the transparent display 2. For this reason, instead of only rotating the mirror 8 about its mirror shaft A1, as is the case in the prior art, the mirror is also lowered by an eccentric that has its own eccentric drive M2, independently of the mirror shaft A1, into its parked position P, as schematically indicated in FIGS. 2-3b.

FIG. 2 shows an example of an eccentric bearing for the mirror shaft A1 for the concave mirror 8 in a transparent display according to one exemplary embodiment of the invention, in a rotating secondary bearing 14 (eccentric bearing). This relates specifically, but not necessarily, to the transparent display 2 shown in FIG. 1.

FIG. 2 shows a cross sectional view looking toward the mirror shaft A1, which is parallel to the eccentric axis A2, at a predetermined radial spacing thereto, purely by way of example. The secondary bearing 14 is rotated 19 about its eccentric axis A2 by an eccentric drive M2. In this example, the eccentric drive M2 has its own motor, the housing for which is indicated by a broken line forming a circle around it, which is covered by a bearing block 17 in FIG. 2, in which the secondary bearing 14 can rotate. The bearing block 17, including the eccentric axis A2, does not move in relation to the projector unit 5 and the housing 10, and is schematically indicated by a rectangle in FIGS. 2-3b. In this example, the eccentric drive M2 also has a tappet 18 with which a torque is transferred from the second motor to the secondary bearing 14, that engages in a nearly form-fitting manner in a hole 20 in the secondary bearing 14, the position of which is indicated merely by way of example in FIG. 2, and the inner dimensions of which are only slightly larger than the outer dimensions of the tappet 18, such that the tappet can still move in the hole 20 when in use.

FIG. 3a shows a longitudinal cut through the concave mirror 8 shown in FIG. 2, and its eccentric position in the rotating secondary bearing 14 looking toward the mirror shaft A1 when the concave mirror 8 is in use. In other words, FIG. 3a shows the concave mirror 8 from a driver's perspective, i.e. looking along the longitudinal axis X for the vehicle 1. FIG. 3b shows the same longitudinal cut shown in FIG. 3a, after the concave mirror 8 has been moved to its parked position P.

As can be seen in FIG. 1, the spacing between the cover lens 11 and the concave mirror 8 is greatest when the mirror shaft A1 is in the angular operating region where it is used to adjust the eyebox position while the projector unit 5 is in use. In the other angular region, where the concave mirror 8 is in the parked position P, the mirror would be too close to the cover lens 11 with the desired antireflecting geometry shown in FIG. 1, due to the asymmetrical windshield and vehicle geometry, seen from the driver's perspective, in particular at the right end of the mirror shaft A1 in FIGS. 3a-3b. To solve this problem, the concave mirror 8 shown in FIGS. 2 and 3a-3b has an eccentric kinematic at the right end of the mirror shaft A1 (although it would also be possible to have such at both ends) for lowering the mirror 8 into the parked position, where it comes close to the cover lens 11.

As FIG. 3a shows, the mirror shaft Al has a primary bearing at its left end, which is fixed in place in relation to the projector unit 5, or in the housing, by a mount, indicated by a triangle. This is also where the mechanical drive unit M1 can be attached, but is by no means the only option. The primary bearing 15 forms a spherical head, allowing for the necessary freedom of movement for the second end of the mirror shaft A1. The other end, forming a floating bearing, can also be a primary bearing 16 in which the right end of the mirror shaft A1 is rotatably supported, which can also form a spherical head. The two primary bearings 15, 16 allow for the movement of the concave mirror 8, in particular to adjust it to the eyebox position in the normal operation of the transparent display 2, which can be done when the vehicle 1 is in use.

The primary bearing 16 is placed off-center in the secondary bearing 14 for this, in that it is in a fixed position at a predetermined distance to the eccentric axis A2 (see FIG. 2), e.g. with a sliding or rolling bearing.

The concave mirror 8 can be moved from any operating position into its parked position P along an optimal path by a rotation of the mirror shaft A1 combined with an independent rotation 19 of the secondary bearing 14. The latter lowers the mirror 8 along the vertical axis Z for the vehicle 1, increasing the distance between the mirror 8 and the cover lens 11 in this example by a vertical difference AZ that is a function of the specific position of the primary bearing 16 in the secondary bearing 14, and its distance to the eccentric axis A2. This lowering AZ is also shown in FIGS. 3a-3b. A lowering at both ends, i.e. at the primary bearing 15 on the other end of the mirror shaft A1, can be obtained in a similar manner.

As an alternative, or in addition, to the movement of the concave mirror 8 into its parked position P described above, a similar lowering or raising of the mirror 8 using an eccentric drive can also be used to adjust it during use, in particular for adjusting the eyebox. The independent rotation 19 of the secondary bearing 14 increases the degree of freedom in adjusting the concave mirror. This can be obtained through an appropriate selection of the geometric parameters for the eccentric bearing of the mirror shaft A1 in the secondary bearing 14 and the temporal functioning of both drive units M1 and M2 to further optimize the optical performance of the transparent display 2 when in use, and/or to make better use of the effective concave mirror surface when adjusting the eyebox, e.g. to reduce the size of the concave mirror, as an alternative, or in addition, to the lowering into the parked position P described above.

Depending on the diameter of the bearing for the mirror shaft A1 in the secondary bearing 14 and the respective time periods for the independent drive units M1 and M2, the eccentrically driven translatory movement of the mirror shaft A1 can be adjusted specifically to a desired design parameter (such as the optical performance of the transparent display 2, installation space restrictions, etc.). In particular, the concave mirror 8 can be lowered significantly more along the Z-axis to reach its parked position P than with conventional systems. The independent control of the two drive units M1 and M2 can take place simultaneously, or separately, as needed. This allows for the distance to the cover lens 11 to be kept as great as possible during the lowering sequence.

### LIST OF REFERENCE SYMBOLS

1 vehicle
2 transparent display
3 windshield
4 dashboard
5 projector unit
6 imaging unit
7 flat mirror
8 concave mirror
9 roof
10 housing
11 cover lens
12 rotation of the mirror shaft
14 secondary bearing
15, 16 primary bearing for the opposite ends of the mirror shaft
17 bearing block
18 tappet
19 rotation of the secondary bearing
20 tappet hole
L light beams
O upper surface of the dashboard
A1 mirror shaft
A2 eccentric axis
E eyebox
M1 drive unit for the mirror shaft, i.e. mirror shaft drive
M2 drive unit for the secondary bearing, i.e. eccentric drive
P parked position of the concave mirror
K coordinate system for the vehicle
X, Y, Z longitudinal, lateral, and vertical axes for the vehicle
V virtual image

1.-10. (canceled)

11. A projector unit for a transparent display for a vehicle, the projector unit comprising:
an imaging unit for generating light beams containing desired display content;
a concave mirror placed in a beam path of the light beams, such that the light beams exit the projector unit in a specific shape and direction, to subsequently be reflected by a partially transparent reflective panel in a user's field of vision into an eyebox, thus showing the user content of the display in a form of a virtual image behind the reflective panel;
wherein:
the concave mirror is rotatable about a mirror shaft connected to the concave mirror by a mirror shaft drive to adjust the eyebox position, which is rotatably supported for this in a primary bearing; and
the primary bearing on one end of the mirror shaft is supported off-center in a secondary bearing, which is drivable by an independently controlled eccentric drive such that the second bearing can be rotated about its eccentric axis, which is fixed in place in relation to the projector unit, to obtain a translatory transversal movement of the mirror shaft, and thus the concave mirror.

12. The projector unit according to claim 11, wherein at least one of:
both the mirror shaft drive and the eccentric drive each has its own independent motor; or
the mirror shaft drive and the eccentric drive have a same motor and a coupling, such that the mirror shaft drive and the eccentric drive can be powered successively and independently.

13. The projector unit according to claim 11, wherein at least one of:
the primary bearing at one or both ends of the mirror shaft forms a spherical head; or
the primary bearing is supported at a fixed position in the secondary bearing.

14. The projector unit according to claim 13, wherein the primary bearing is supported at the fixed position in the secondary bearing at a fixed point at a predetermined radial distance to the eccentric axis with a sliding or rolling bearing.

15. The projector unit according to claim 11, further comprising:
a housing that protects the projector unit toward an exterior; and
a transparent cover lens, that closes the housing to the exterior, and transmits light beams emitted by the projector unit; wherein:
the concave mirror is placeable in a parked position by angling the mirror shaft to a specific position, in which a focus or an optical axis of the concave mirror lies outside a beam path of the projector unit when in use; and
when moving the concave mirror from an operating position into the parked position, a rotation of the secondary bearing by the eccentric drive results in a translatory movement of the mirror shaft, and therefore the mirror, away from the cover lens.

16. The projector unit according to claim 11, wherein:
the mirror shaft and the eccentric axis are parallel and at a predetermined spacing to one another; or
the mirror shaft and the eccentric axis are angled in relation to one another.

17. The projector unit according to claim 11, wherein:
lengths of at least one of the mirror shaft, the primary bearings, or the secondary bearing are automatically adjustable, such that the length of the mirror shaft is automatically adjusted to a distance between the primary bearings at its ends when the secondary bearing rotates.

18. A method for operating a projector unit according to claim 11, the method comprising at least one of:
driving the mirror shaft by the mirror shaft drive and driving the secondary bearing by the eccentric drive, successively or simultaneously, to adjust the concave mirror when the projector unit is in use, in order to adjust the eyebox position; or
driving the mirror shaft by the mirror shaft drive and driving the secondary bearing by the eccentric drive, successively or simultaneously, to move the concave mirror into its parked position.

19. A control unit configured to automatically execute the method according to claim 18.

20. A transparent display for a vehicle, the transparent display comprising:
the projector unit according to claim 11;
the partially transparent reflective panel placed in the beam path of the light beams emitted by the projector unit.

21. A vehicle with longitudinal, lateral, and vertical axes of a cartesian coordinate system for the vehicle, the vehicle comprising:
a windshield that at least partially delimits a front of a passenger compartment, and
the transparent display according to claim 20, wherein:
the projector unit is placed in the passenger compartment, inside the dashboard underneath the windshield, or directly beneath the upper surface of the dashboard; and
the reflective panel is part of the windshield, or is a combiner panel in the passenger compartment; and
translatory movement of the mirror shaft resulting from rotation of the secondary bearing causes a lowering or raising of the mirror at one or both sides along the vertical axis of the cartesian coordinate system for the vehicle.
